(19) United States
(12) Patent Application Publication
(10) Pub. No.: US 2025/0212266 A1
(43) Pub. Date: Jun. 26, 2025

(54) FIRST ELECTRONIC DEVICE, SECOND ELECTRONIC DEVICE, AND DEVICE CONNECTION METHOD

(71) Applicant: SEIKO EPSON CORPORATION, Tokyo (JP)

(72) Inventor: Keiichi MORIMOTO, MATSUMOTO-SHI (JP)

(21) Appl. No.: 18/985,444

(22) Filed: Dec. 18, 2024

(30) Foreign Application Priority Data
Dec. 21, 2023 (JP) 2023-215685

(51) Int. Cl. H04W 76/10; H04W 4/80; H04W 48/16

(52) U.S. Cl. CPC H04W 76/10; H04W 4/80; H04W 48/16

(57) ABSTRACT

A first electronic device according to an aspect of the present disclosure includes a first wireless communication unit, a second wireless communication unit, and a communication controller configured to control the first and second wireless communication units. The first wireless communication unit performs first wireless communication with a terminal device. The second wireless communication unit performs Bluetooth communication with a second electronic device. The communication controller searches for an electronic device that is a candidate for the second electronic device via the second wireless communication unit, acquires, from the terminal device via the first wireless communication unit, instruction information instructing connection with the second electronic device to perform Bluetooth communication with the second wireless communication unit from among candidates obtained by searching, and transmits a connection request by the second communication method to the second electronic device indicated by the instruction information.

The present application is based on, and claims priority from JP Application Serial Number 2023-215685, filed Dec. 21, 2023, the disclosure of which is hereby incorporated by reference herein in its entirety.

### BACKGROUND

### 1. Technical Field

The present disclosure relates to a first electronic device, a second electronic device, and a device connection method.

### 2. Related Art

JP-A-2016-150484 discloses a configuration in which devices are paired with each other via Bluetooth (registered trademark; the same applies below).

However, the technique described in JP-A-2016-150484 has room for improvement in terms of simplifying a connection operation when Bluetooth connection is performed only for an electronic device to be connected.

Therefore, there is a need for development of a technique capable of simplifying a connection operation for performing Bluetooth communication with an electronic device to be connected.

### SUMMARY

A first electronic device according to an aspect of the present disclosure includes: a first wireless communication unit configured to perform first wireless communication with a terminal device by a first communication method; a second wireless communication unit configured to perform Bluetooth communication with a second electronic device by a second communication method that is a communication method conforming to a Bluetooth standard; and a communication control unit configured to control the first wireless communication unit and the second wireless communication unit, in which the communication control unit performs searching for an electronic device that is a candidate for the second electronic device, via the second wireless communication unit, acquires, from the terminal device via the first wireless communication unit, instruction information instructing connection with the second electronic device to perform Bluetooth communication with the second wireless communication unit from among candidates obtained by the searching, and transmits a connection request by the second communication method to the second electronic device indicated by the instruction information.

A second electronic device according to an aspect of the present disclosure includes: a wireless communication unit configured to perform Bluetooth communication with a first electronic device by a communication method conforming to a Bluetooth standard; and a communication control unit configured to control the wireless communication unit, in which the communication control unit receives, via the wireless communication unit, a transmission request for transmitting device information from the first electronic device to perform the Bluetooth communication, in response to the transmission request, transmits the device information to the first electronic device via the wireless communication unit, receives a connection request by the communication method from the first electronic device, in response to the connection request, attempts connection with the first electronic device via the wireless communication unit to perform the Bluetooth communication with the first electronic device, and when the connection with the first electronic device fails, receives again a connection request by the communication method transmitted from the first electronic device based on the device information.

A device connection method according to an aspect of the present disclosure includes: by a first electronic device including a first wireless communication unit configured to perform first wireless communication with a terminal device by a first communication method and a second wireless communication unit configured to perform Bluetooth communication with a second electronic device by a second communication method that is a communication method conforming to a Bluetooth standard, searching for an electronic device that is a candidate for the second electronic device, via the second wireless communication unit; acquiring, from the terminal device via the first wireless communication unit, instruction information instructing connection with the second electronic device to perform Bluetooth communication with the second wireless communication unit from among candidates obtained by the searching; and transmitting a connection request by the second communication method to the second electronic device indicated by the instruction information.

A device connection method according to another aspect of the present disclosure includes: by a second electronic device including a wireless communication unit configured to perform Bluetooth communication with a first electronic device by a communication method conforming to a Bluetooth standard, receiving, via the wireless communication unit, a transmission request for transmitting device information from the first electronic device to perform the Bluetooth communication; in response to the transmission request, transmitting the device information to the first electronic device via the wireless communication unit; receiving a connection request by the communication method from the first electronic device; in response to the connection request, attempting connection with the first electronic device via the wireless communication unit to perform the Bluetooth communication with the first electronic device; and when the connection with the first electronic device fails, receiving again a connection request by the communication method transmitted from the first electronic device based on the device information.

### BRIEF DESCRIPTION OF THE DRAWINGS

FIG. 1 is a block diagram showing a configuration example of a communication system including a first electronic device according to an embodiment.

FIG. 2 is a flow diagram showing a processing example of a first electronic device in the communication system in FIG. 1.

FIG. 3 is a schematic diagram showing an example of transition of a state of the communication system in FIG. 1.

FIG. 4 is a schematic diagram showing an example of transition following FIG. 3.

FIG. 5 is a schematic diagram showing an example of transition of an operation image displayed on a terminal device in the communication system in FIG. 1 in the examples of transition in FIGS. 3 and 4.

FIG. 6 is a schematic diagram showing another example of transition of a state of the communication system in FIG. 1.

FIG. 7 is a schematic diagram showing an example of transition of an operation image displayed on the terminal device in the communication system in FIG. 1 in the example of transition in FIG. 6.

FIG. 8 is a flow diagram showing another processing example of the first electronic device in the communication system in FIG. 1.

FIG. 9 is a flow diagram showing a processing example in the communication system in FIG. 1 corresponding to the processing example in FIG. 8.

FIG. 10 is a schematic diagram showing an example of transition of a state of the communication system in FIG. 1 based on the processing example in FIG. 8.

FIG. 11 is a schematic diagram showing an example of transition of an operation image displayed on the terminal device in the communication system in FIG. 1 in the example of transition in FIG. 10.

FIG. 12 is a diagram showing an example of a hardware configuration of a device.

### DESCRIPTION OF EMBODIMENTS

Hereinafter, an embodiment of the present disclosure will be described with reference to the drawings. The drawings are merely an example showing the embodiment of the present disclosure. Not all of the components described in the embodiment of the present disclosure are essential components of the present disclosure.

### EMBODIMENT

### System Configuration Example

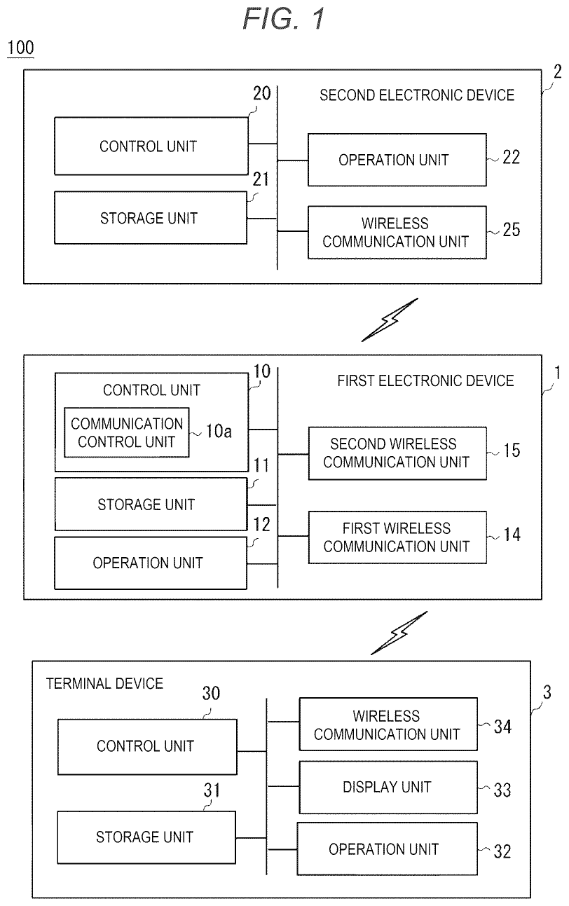

A communication system including a first electronic device according to an embodiment will be described with reference to FIG. 1. FIG. 1 is a block diagram showing a configuration example of such a communication system.

As shown in FIG. 1, a communication system 100 according to the embodiment may include a first electronic device 1, a second electronic device 2, and a terminal device 3. Hereinafter, a schematic configuration example of the terminal device 3, the second electronic device 2, and the first electronic device 1 will be described in this order.

### Schematic Configuration Example of Terminal Device 3

The terminal device 3 is used to perform connection for performing Bluetooth communication between the first electronic device 1 and the second electronic device 2. The terminal device 3 may be a device having a communication function such as a smartphone, a tablet terminal, or a personal computer (PC). The terminal device 3 is not limited to a portable type device, and may be an installation type device. As illustrated in FIG. 1, the terminal device 3 may include a control unit 30, a storage unit 31, an operation unit 32, a display unit 33, and a wireless communication unit 34.

The control unit 30 controls the entire terminal device 3. The control unit 30 may include an arithmetic processing device such as a central processing unit (CPU) or a graphics processing unit (GPU), a working memory, and a storage device that stores a control program, parameters, and so on. The control unit 30 may also be implemented as a system on a chip (SoC). The control unit 30 may be provided with a configuration in which the control program is stored in an executable state. The control unit 30 may have a configuration in which the control program is stored as a circuit configuration such as a field-programmable gate array (FPGA), or may be implemented as a dedicated circuit. The program may include a program for implementing functions of the terminal device 3 in cooperation with the storage unit 31, the operation unit 32, the display unit 33, and the wireless communication unit 34. The control unit 30 may include a communication control unit that controls communication in the wireless communication unit 34. However, for the sake of simplicity, the following description will be given on the assumption that the control unit 30 also controls the wireless communication unit 34.

The functions of the terminal device 3 include a display function of displaying, on the display unit 33, a user interface (UI) image that is an operation image used when connection for Bluetooth communication is performed between the first electronic device 1 and the second electronic device 2. Displaying a UI image on the display unit 33 may be displaying a UI image provided from the first electronic device 1 on a browser. The functions of the terminal device 3 include a function of receiving a user operation from the operation unit 32 for the UI image.

The storage unit 31 is, for example, a hard disk drive, a solid state drive, or any other type of memory. A part of the memory provided to the control unit 30 may be regarded as the storage unit 31. That is, the storage unit 31 may also be regarded as a part of the control unit 30.

The display unit 33 is a region for displaying information. The display unit 33 can display a UI image that is an operation image provided from the first electronic device 1 as at least a part of the information. The display unit 33 is formed of, for example, a display device such as a liquid crystal display or an organic EL display. The display unit 33 may have a configuration including a display and a drive circuit for driving the display.

The operation unit 32 is a region that receives an operation or an input by a user, and may also be referred to as an operation reception unit. The operation unit 32 can receive an operation for the operation image displayed on the display unit 33. The operation unit 32 can be implemented by any one or more of, for example, physical buttons, a touch panel or a touch sensor installed in the display unit 33, a pointing device, and a keyboard. In a configuration in which the operation unit 32 includes the touch panel or the touch sensor, the display unit 33 and the touch panel may collectively be referred to as an operation panel of the terminal device 3.

The wireless communication unit 34 performs wireless communication with a first wireless communication unit 14 of the first electronic device 1 to be described later. The wireless communication unit 34 may be a communication interface for the terminal device 3 to wirelessly communicate with an external device in accordance with a communication protocol of a first communication method. In the communication system 100, the external device may be the first electronic device 1, but may also be another device.

### Schematic Configuration Example of Second Electronic Device 2

The second electronic device 2 may be a device having a communication function, such as a smartphone, a tablet terminal, a PC, a printer, a handy terminal, an automatic change machine, or a credit card payment terminal. The handy terminal can be equipped with a scanning function for reading barcodes or the like. The second electronic device 2 is not limited to a portable type device, and may be an installation type device. As illustrated in FIG. 1, the second electronic device 2 may include a control unit 20, a storage unit 21, an operation unit 22, and a wireless communication unit 25.

The control unit 20 can also be referred to as a controller, and controls the entire second electronic device 2. The control unit 20 may include an arithmetic processing device such as a CPU or a GPU, a working memory, and a storage device that stores a control program, parameters, and so on. The control unit 20 may instead be implemented as an SoC. The control unit 20 may be provided with a configuration in which the control program is stored in an executable state. The control unit 20 may have a configuration in which the control program is stored as a circuit configuration such as a field-programmable gate array (FPGA), or may be implemented as a dedicated circuit. The program may include a program for implementing functions of the second electronic device 2 in cooperation with the storage unit 21, the operation unit 22, and the wireless communication unit 25. The control unit 20 may include a communication control unit that controls communication in the wireless communication unit 25. However, for the sake of simplicity, the following description will be given on the assumption that the control unit 20 also controls the wireless communication unit 25.

The storage unit 21 is, for example, a hard disk drive, a solid state drive, or any other type of memory. A part of the memory provided to the control unit 20 may be regarded as the storage unit 21. That is, the storage unit 21 may also be regarded as a part of the control unit 20.

The operation unit 22 is a region that receives an operation or an input by a user, and may also be referred to as an operation reception unit. The operation unit 22 can be implemented by, for example, a physical button. The operation unit 22 may be implemented by an operation unit other than a physical button, similarly to the operation unit 32 of the terminal device 3.

The wireless communication unit 25 performs wireless communication with a second wireless communication unit 15 of the first electronic device 1 to be described later. The wireless communication unit 25 may be a communication interface for the second electronic device 2 to wirelessly communicate with an external device in accordance with a communication protocol of the second communication method. In the communication system 100, the external device may be the first electronic device 1, but may also be another device.

Although not illustrated, the second electronic device 2 may also include a display unit for displaying information, similarly to the terminal device 3. The second electronic device 2 can also constitute an operation panel with the display unit and the operation unit 22. As will be described later, it can be said that when the second electronic device 2 does not include such a display unit, an effect of executing connection processing between the first electronic device 1 and the second electronic device 2 using the terminal device 3 in the communication system 100 is greater.

### Schematic Configuration Example of First Electronic Device

The first electronic device 1 may be a concentrator having a function of communicating with a plurality of electronic devices. The concentrator may be simply referred to as a hub. Alternatively, the first electronic device 1 may be a device having a communication function such as a smartphone, a tablet terminal, or a PC. The first electronic device 1 is not limited to a portable type device, and may be an installation type device.

The first electronic device 1 may include a control unit 10 including a communication control unit 10a, a storage unit 11, an operation unit 12, the first wireless communication unit 14, and the second wireless communication unit 15.

The control unit 10 can also be referred to as a controller, and controls the entire first electronic device 1. The control unit 10 may include the communication control unit 10a that controls communication in the first wireless communication unit 14 and the second wireless communication unit 15.

The control unit 10 may include an arithmetic processing device such as a CPU or a GPU, a working memory, and a storage device that stores a control program, parameters, and so on. The control unit 10 or the communication control unit 10a can also be implemented as an SoC. The control unit 10 may be provided with a configuration in which the control program is stored in an executable state. The control unit 10 may be configured to store the control program as a circuit configuration such as an FPGA, or may be implemented as a dedicated circuit. The program may include a program for implementing functions of the first electronic device 1 in cooperation with the storage unit 11, the operation unit 12, the first wireless communication unit 14, and the second wireless communication unit 15.

The storage unit 11 is, for example, a hard disk drive, a solid state drive, or any other type of memory. A part of the memory provided to the control unit 10 may be regarded as the storage unit 11. That is, the storage unit 11 may also be regarded as a part of the control unit 10.

The operation unit 12 is a region that receives an operation or an input by a user, and may also be referred to as an operation reception unit. The operation unit 12 can be implemented by, for example, a physical button. The operation unit 12 may be implemented by an operation unit other than a physical button, similarly to the operation unit 32 of the terminal device 3.

The first wireless communication unit 14 performs first wireless communication with the terminal device 3 by the first communication method. The first wireless communication unit 14 may be a communication interface for the first electronic device 1 to wirelessly communicate with an external device in accordance with a communication protocol of the first communication method. In the communication system 100, the external device may be the terminal device 3, but may also be another device.

The second wireless communication unit 15 performs second wireless communication with the second electronic device 2 by the second communication method. The second wireless communication unit 15 may be a communication interface for the first electronic device 1 to wirelessly communicate with an external device in accordance with a communication protocol of the second communication method. In the communication system 100, the external device may be the second electronic device 2, but may also be another device. Here, the second communication method is a communication method conforming to a Bluetooth standard. A version of the Bluetooth standard does not matter. For example, the Bluetooth standard may be Bluetooth Low Energy. Hereinafter, wireless communication by a communication method conforming to the Bluetooth standard and connection therefor are referred to as BT communication and BT connection, respectively.

The first communication method that is a communication method used by the first wireless communication unit 14 can be, for example, a communication method conforming to a Wi-Fi (registered trademark; the same applies below) standard. The Wi-Fi standard refers to, for example, a standard of IEEE (Institute of Electrical and Electronics Engineers) 802.11 and a derived standard thereof. Thus, a version of the Wi-Fi standard does not matter. Hereinafter, wireless communication based on a communication method conforming to the Wi-Fi standard is referred to as Wi-Fi communication.

The first communication method may be a communication method conforming to a Wi-Fi Direct standard, and an example of such a method will be described below. Hereinafter, wireless communication based on a communication method conforming to the Wi-Fi Direct standard is referred to as Wi-Fi Direct communication. Since connection for the Wi-Fi Direct communication can be easily performed, it can be said that setting of the BT communication using the terminal device 3 can also be easily performed.

The first communication method may be another communication method, and may not be a communication method different from the second communication method but may be the same communication method, that is, a communication method conforming to the Bluetooth standard. The first communication method may be, for example, a communication method conforming to another short-range wireless communication standard such as Zigbee (registered trademark) or a communication method conforming to a communication standard such as a fourth generation mobile communication system or a fifth generation mobile communication system.

In order to improve user convenience, the first communication method may be determined such that a communication speed between the first electronic device 1 and the terminal device 3 is faster than a communication speed between the first electronic device 1 and the second electronic device 2. There may be no difference in the communication speed between the first communication method and the second communication method. The second communication method may be a communication method having a communication speed faster than the first communication method.

As described above, an example in which the first wireless communication unit 14 performs Wi-Fi Direct communication with the terminal device 3 and the second wireless communication unit 15 performs BT communication with the second electronic device 2 will be described below. In the communication system 100, the user operates the terminal device 3 to set connection for the BT communication using the Wi-Fi Direct communication.

For such setting, first, the communication control unit 10a searches for an electronic device serving as a candidate for the second electronic device 2, via the second wireless communication unit 15. Then, the communication control unit 10a transmits a search result to the terminal device 3 via the first wireless communication unit 14 by Wi-Fi Direct communication.

The terminal device 3 that receives the search result may display the search result as a UI image on the display unit 33 and receive an operation to select a connection partner from the operation unit 32. The control unit 30 of the terminal device 3 transmits, to the first electronic device 1 via the wireless communication unit 34 by Wi-Fi Direct communication, instruction information instructing connection to the second electronic device 2 to perform BT communication with the second wireless communication unit 15, from among candidates obtained by searching.

The communication control unit 10a acquires the instruction information by receiving the instruction information from the terminal device 3 via the first wireless communication unit 14. Then, the communication control unit 10a transmits a connection request by the second communication method to the second electronic device 2 indicated by the instruction information. This connection request can be referred to as a BT connection request, and can include a Bluetooth pairing request.

### Processing Example of First Electronic Device 1

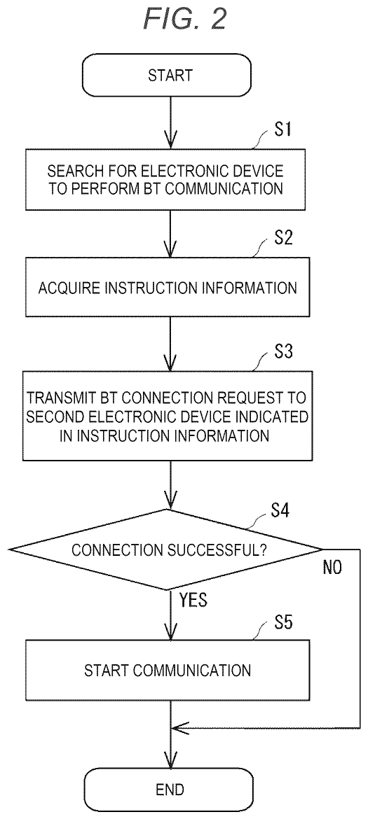

The processing example of the first electronic device 1 in the communication system 100 will be described with reference to FIG. 2. FIG. 2 is a flow diagram showing such a processing example. This processing example is an example of device connection processing for BT connection between the first electronic device 1 and the second electronic device 2.

The communication control unit 10a searches for an electronic device to perform BT communication via the second wireless communication unit 15 (step S1). Next, the communication control unit 10a acquires the instruction information from the terminal device 3 via the first wireless communication unit 14 (step S2).

Next, the communication control unit 10a transmits a connection request by the second communication method, that is, a BT connection request, to the second electronic device 2 indicated by the instruction information (step S3). When a response to the BT connection request is received from the second electronic device 2, the communication control unit 10a performs BT pairing with the second electronic device 2 to establish the BT connection. When there is a response to reject the BT connection as the response, the BT connection is not established. However, for example, the second electronic device 2 may be set in advance to transmit a response for permitting connection in response to the BT connection request.

The communication control unit 10a determines whether the BT connection is successful as a result of the BT connection request (step S4). In a case of YES in step S4, that is, when the BT connection is successful, the communication control unit 10a starts BT communication with the second electronic device 2 (step S5), and ends the processing. On the other hand, in a case of NO in step S4, that is, when the BT connection is not possible or is rejected, the communication control unit 10a ends the processing.

### Processing Example of Communication System 100

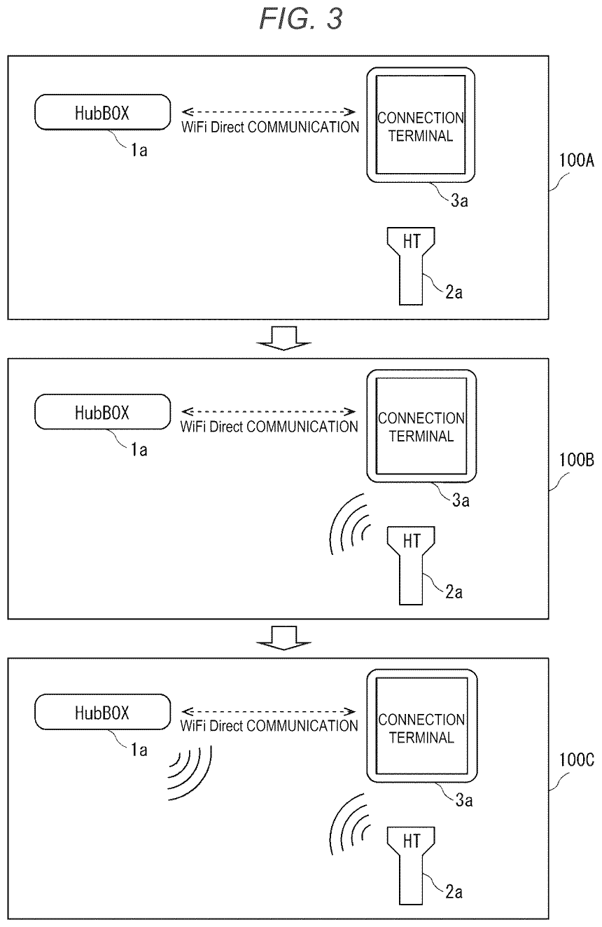

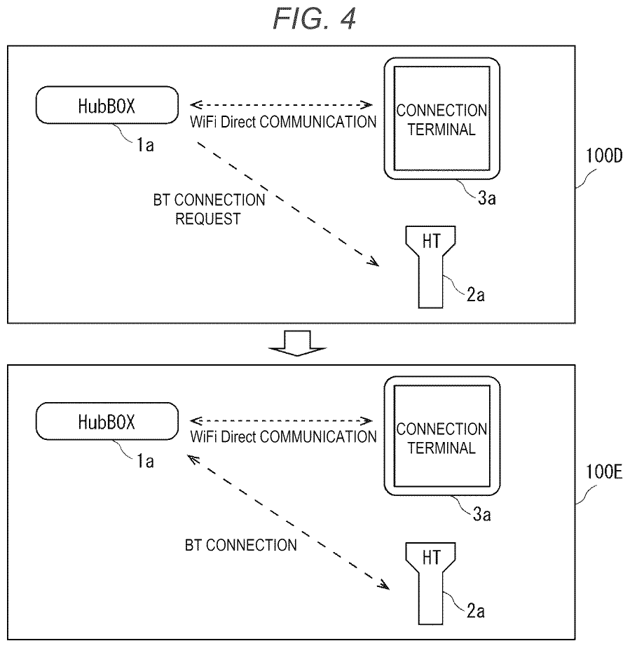

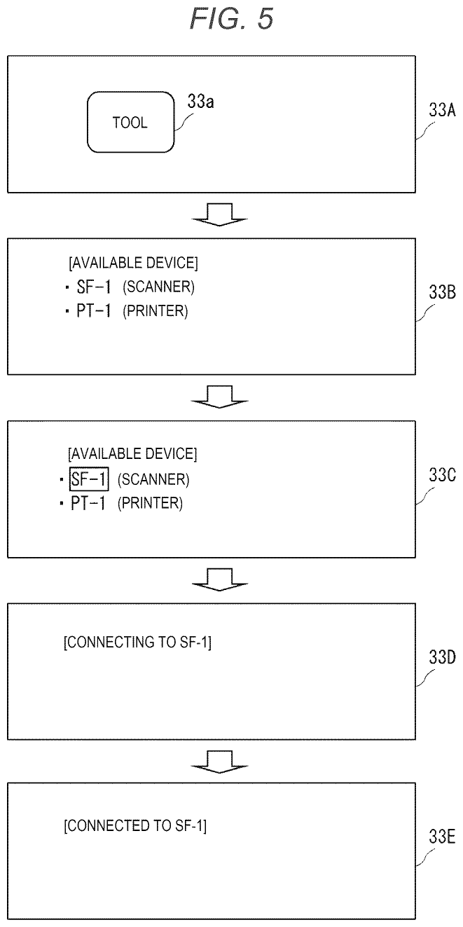

Hereinafter, specific processing examples including not only processing on a first electronic device 1 side but also processing in the terminal device 3 and the second electronic device 2 will be described with reference to FIGS. 3 to 5. FIG. 3 is a schematic diagram showing an example of transition of a state of the communication system 100. FIG. 4 is a schematic diagram showing an example of transition following FIG. 3. FIG. 5 is a schematic diagram showing an example of transition of a UI image displayed on the terminal device in the communication system in FIG. 1 in the examples of transition in FIGS. 3 and 4.

Here, an example in which the first electronic device 1 is a concentrator (hereinafter, referred to as HubBOX) 1a and the second electronic device 2 is a handy terminal (hereinafter, referred to as HT) 2a will be described. In the description, the terminal device 3 is referred to as a connection terminal 3a, and the HubBOX 1a is referred to as an HB 1a.

First, as shown in a communication system 100A in FIG. 3, an example will be described in which the communication system 100 performs setting to perform BT communication between the HB 1a and the HT 2a from a state in which the HB 1a and the connection terminal 3a perform Wi-Fi Direct communication.

The user starts a tool application for such setting on the connection terminal 3a. Hereinafter, the tool application is simply referred to as a tool. The tool may be installed in the connection terminal 3a in advance. By this installation, the connection terminal 3a may display on the display unit 33 an icon 33a for opening the tool, as in a UI image 33A shown in FIG. 5. When the user selects the icon 33a from the operation unit 32, the tool is started. The tool may simply be a browser that receives the UI image for performing the BT connection from the HB 1a and displays the UI image.

A state shown in the communication system 100A is changed to a state shown in a communication system 100B in which the HT 2a is set to a BT pairing enabled state. Transition to such a state in the HT 2a may be automatically executed simply when power is turned on, or may be executed when the user presses a button on the operation unit 22 provided in the HT 2a. The transition to such a state in the HT 2a may be performed before the start of the tool.

When the tool is started, the connection terminal 3a notifies the HB 1a of the startup. Upon receiving this notification, the HB 1a searches for an available device as a partner for BT communication. Here, the state shown in the communication system 100B is changed to a state shown in a communication system 100C in which the HB 1a and the HT 2a are in a BT pairing enabled state.

A search result is transmitted to the connection terminal 3a, and a list of available devices is displayed as illustrated in a UI image 33B. The user selects one device from the operation unit 32. For example, as illustrated in a UI image 33C, SF-1 is selected from devices SF-1 and PT-1 in the list and highlighted. Here, the SF-1 is assumed to be an HT 2a equipped with a scanner function. It is assumed that the PT-1 is a printer.

The connection terminal 3a transmits, to the HB 1a, by Wi-Fi Direct communication, via the wireless communication unit 34, instruction information instructing connection with the SF-1 selected by the user.

The HB 1a receives the instruction information from the connection terminal 3a via the first wireless communication unit 14. As in a state shown in a communication system 100D in FIG. 4, the HB 1a transmits a BT connection request to the SF-1 indicated by the instruction information. In this state, the connection terminal 3a may display a message indicating that the HB 1a is connecting to the SF-1 as illustrated in a UI image 33D in FIG. 5.

When the HT 2a responds to the BT connection request with connection permission, the BT communication becomes possible between HB 1a and HT 2a as in a state shown in a communication system 100E in FIG. 4. In such a state, the connection terminal 3a may display a message indicating the connection with the SF-1 is completed, as illustrated in a UI image 33E in FIG. 5. The UI image 33E may be erased after a certain period of time or by a user operation.

### Effects of Embodiment

As described above, according to the embodiment, a connection operation for performing the BT communication with the electronic device to be connected can be simplified, and convenience of the BT connection operation can be improved.

As a comparative example, an example is given in which BT connection is established using operation buttons on main bodies of the first electronic device and the second electronic device. In such a comparative example, since the BT connection is established with an electronic device close to the first electronic device, BT connection between the first electronic device and an electronic device other than a targeted second electronic device may be established. On the other hand, in the embodiment, since it is possible to perform the BT connection while checking information on a connection partner using the terminal device 3, it is possible to reliably perform BT connection between a targeted second electronic device 2 and the first electronic device 1.

In particular, in the present embodiment, even when neither the first electronic device 1 nor the second electronic device 2 includes an operation panel, the user can easily use the terminal device 3 to perform a BT connection operation between the first electronic device 1 and the second electronic device 2 that the user desires. Even when one or both of the first electronic device 1 and the second electronic device 2 are provided with an operation panel, it can be said to be beneficial because the user can make settings on the terminal device 3 without going to a vicinity of both electronic devices.

### Another Processing Example 1 of Communication System 100

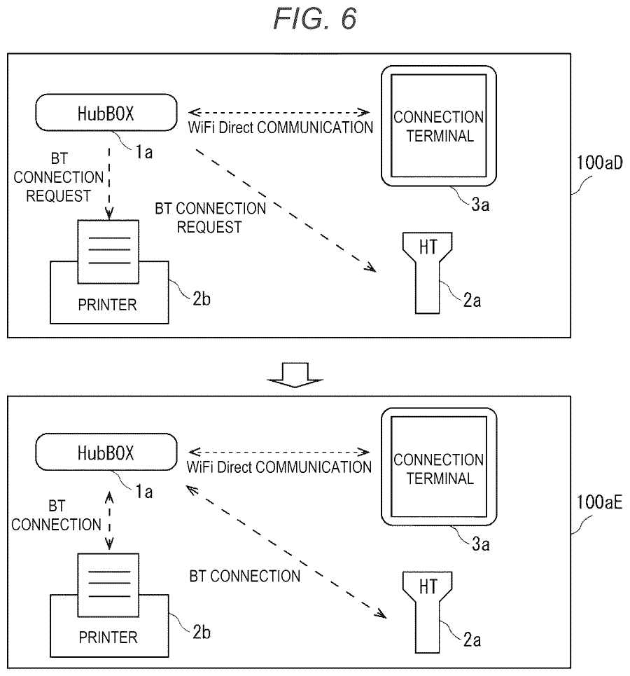

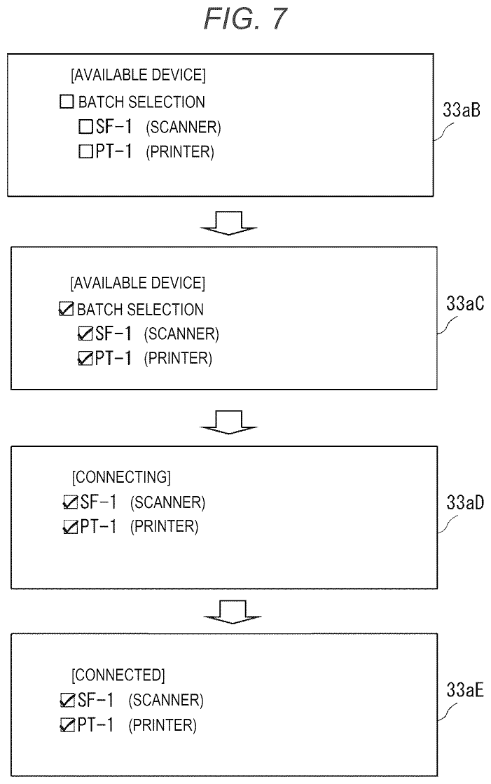

Another processing example of the communication system 100 will be described with reference to FIGS. 6 and 7. FIG. 6 is a schematic diagram showing another example of transition of a state of the communication system 100. FIG. 7 is a schematic diagram showing an example of transition of a UI image displayed on the connection terminal 3a that is an example of the terminal device 3 in the example of transition in FIG. 6.

The processing example described here is an example in which a plurality of second electronic devices 2 are BT-connected to the first electronic device 1 in a batch. In this processing example as well, an example is given in which the first electronic device 1 is the HB 1a, the second electronic device 2 is the HT 2a, and the terminal device 3 is the connection terminal 3a. Here, an example is given in which a printer 2b is also present as the second electronic device 2, and differences from the processing example described with reference to FIGS. 3 to 5 will be described.

When a tool is started, the connection terminal 3a notifies the HB 1a of the startup. Upon receiving this notification, the HB 1a searches for an available device as a partner for BT communication. Here, although not shown in the drawing, in the communication system 100, the HT 2a and the printer 2b described below with reference to FIG. 6 are in a BT pairing enabled state with the HB 1a.

A search result is transmitted to the connection terminal 3a, and a list of available devices is displayed as illustrated in a UI image 33aB in FIG. 7. The list includes the devices SF-1 and PT-1, and the UI image 33aB may include a selection area in which the devices in the list can be selected in a batch. Accordingly, the user can select all the devices in a batch from the operation unit 32. For example, as illustrated in a UI image 33aC, all devices in the list are selected.

The connection terminal 3a transmits, to the HB 1a, by Wi-Fi Direct communication, via the wireless communication unit 34, instruction information instructing connection with the SF-1 and the PT-1 selected by the user.

The HB 1a receives the instruction information from the connection terminal 3a via the first wireless communication unit 14. As shown in a state shown in a communication system 100aD in FIG. 6, the HB 1a transmits a BT connection request to the SF-1 and the PT-1 indicated by the instruction information, that is, the HT 2a and the printer 2b. The transmission may be performed by the communication control unit 10a. In this state, the connection terminal 3a may display a message indicating that the HB 1a is connecting to the SF-1 and the PT-1 as illustrated in a UI image 33aD in FIG. 7.

When the HT 2a and the HT 2b respond to the BT connection request with connection permission from both devices, the BT communication becomes possible between the HB 1a and the HT 2a, and between the HB 1a and the printer 2b, as in a state shown in a communication system 100aE in FIG. 6. In such a state, the connection terminal 3a may display a message indicating that the connection with the SF-1 and the PT-1 is completed, as illustrated in a UI image 33aE in FIG. 7. The UI image 33aE may be erased after a certain period of time or by a user operation.

As in the processing example, when information instructing connection to a plurality of electronic devices serving as the second electronic device 2 is acquired as instruction information from the terminal device 3, the communication control unit 10a may transmit a BT connection request to the plurality of electronic devices indicated by the instruction information. In the processing example, user convenience can be further improved by transmitting such BT connection requests in a batch.

### Another Processing Example 2 of Communication System 100

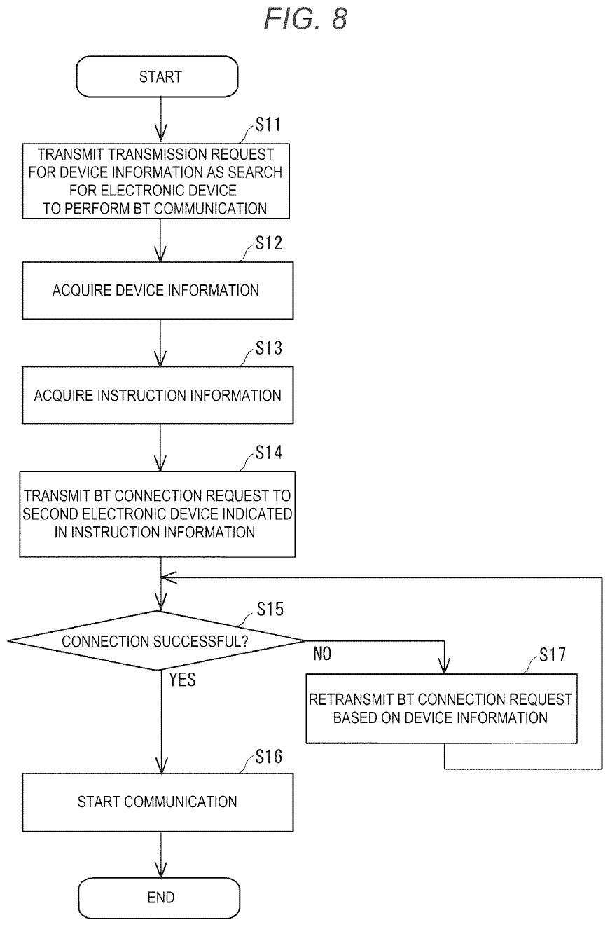

The processing example 2 that is another processing example of the communication system 100 will be described with reference to FIGS. 8 to 11. First, processing of the first electronic device 1 in the processing example 2 will be described with reference to FIG. 8. FIG. 8 is a flow diagram showing a processing example of the first electronic device 1 in the processing example 2.

In the processing example using FIG. 2 or FIGS. 3 to 5, the processing is ended when the BT connection fails. However, in the processing example 2, when the BT connection fails, the BT connection request is transmitted again according to device information. Specifically, the processing example 2 will be described in detail.

In the processing example 2, the communication control unit 10a searches for electronic devices that are candidates for the second electronic device 2 via the second wireless communication unit 15, or transmits a transmission request via the second wireless communication unit 15 to the candidates obtained by searching to request transmission of device information. Since the transmission request is a request for acquiring the device information, the transmission request may be referred to as an acquisition request. Here, the device information can also be referred to as information on device. The device information may include, for example, a vendor ID, a product ID, or a vendor ID and a product ID. Device information on the second electronic device 2 received by the first electronic device 1 may be any information that can specify whether the device is capable of handling the processing here. Device information on the first electronic device 1 received by the second electronic device may be any information that can specify whether the device is capable of handling the processing here.

Next, the communication control unit 10a receives and acquires the device information via the second wireless communication unit 15 as a response to the transmission request (step S12). Accordingly, the communication control unit 10a can recognize, based on the received device information, whether the device obtained by searching is capable of handling processing of step S17 to be described later. Next, the communication control unit 10a acquires instruction information from the terminal device 3 via the first wireless communication unit 14 (step S13). When the devices are selected in a batch from the terminal device 3, the instruction information includes information indicating that all the devices obtained by searching are set as the second electronic device 2 and are BT connection targets.

Next, the communication control unit 10a transmits a BT connection request to the second electronic device 2 indicated by the instruction information as in step S3 in FIG. 2 (step S14). When a response to the BT connection request is received from the second electronic device 2, the communication control unit 10a performs BT pairing with the second electronic device 2 to establish BT connection.

The communication control unit 10a determines whether the BT connection is successful as a result of the BT connection request (step S15). In a case of YES in step S15, that is, when the BT connection is successful, the communication control unit 10a starts BT communication with the second electronic device 2 (step S16), and ends the processing.

On the other hand, in a case of NO in Step S15, that is, when connection to any one of the second electronic devices 2 indicated by the instruction information fails, the communication control unit 10a retransmits a BT connection request to the second electronic device 2 based on the device information on the second electronic device 2 that fails in connection (step S17). After the processing of step S17, the processing of step S15 is executed, and the processing continues until the BT communication becomes possible. A predetermined threshold value may be set for the number of times that the BT connection request is retransmitted, and even in a situation where the BT communication is not possible, when the predetermined threshold value is exceeded, the processing may be ended.

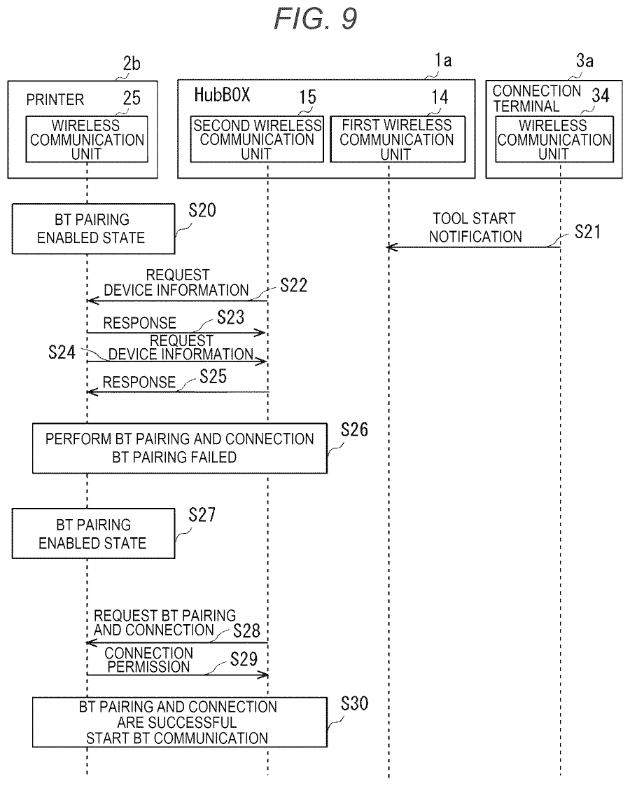

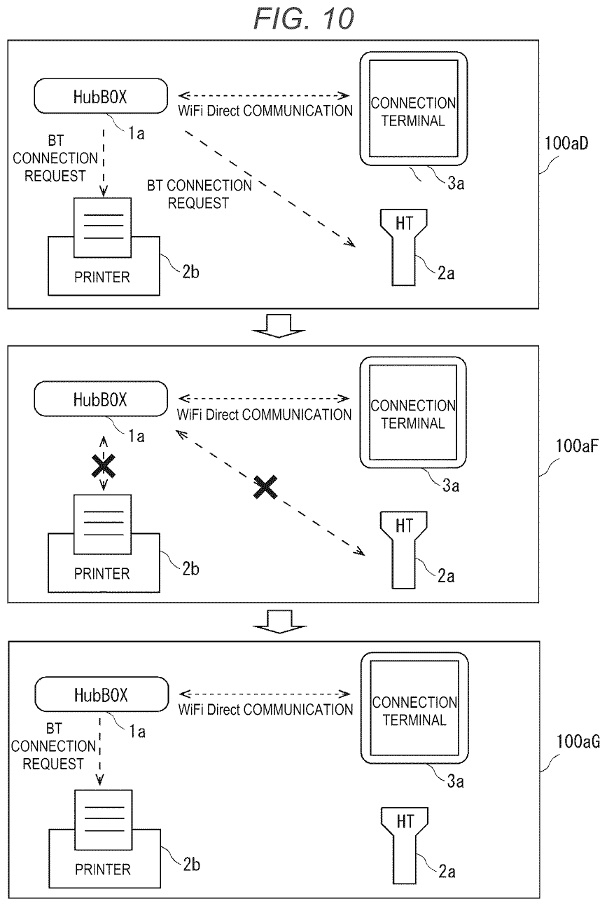

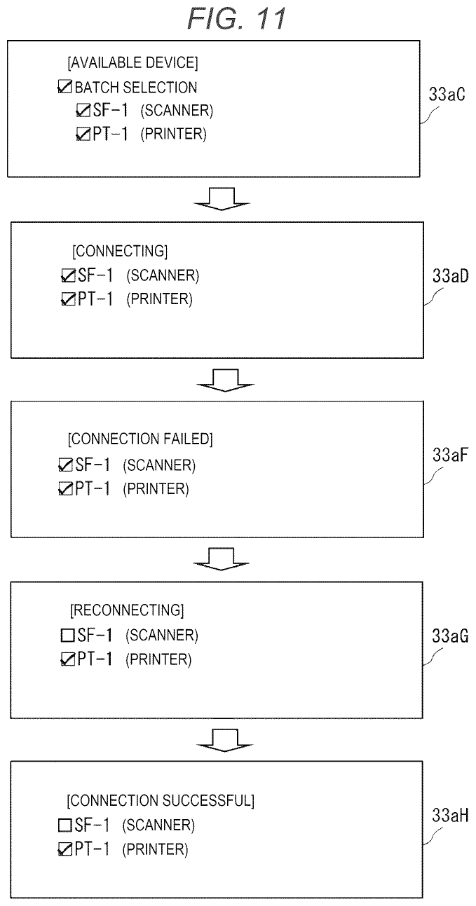

Next, with regard to the processing example 2, a specific processing example including not only the processing on the first electronic device 1 side but also the processing in the terminal device 3 and the second electronic device 2 will be described with reference to FIGS. 9 to 11. FIG. 9 is a flow diagram showing a processing example in the communication system 100 corresponding to the processing example in FIG. 8. FIG. 10 is a schematic diagram showing an example of transition of a state of the communication system 100 based on the processing example in FIG. 8. FIG. 11 is a schematic diagram showing an example of transition of a UI image displayed on the terminal device 3 in the communication system 100 in the example of transition in FIG. 10. In the following, a difference from the processing example 1 will be described as a processing example 2, but a configuration in which batch selection is not possible as in the processing example 1 may be adopted.

In the processing example in FIG. 9, an example is given in which the communication system 100 includes the HB 1a as the first electronic device 1 and the printer 2b as the second electronic device 2. However, in reality, similarly to the processing example 1, the HT 2a is also provided as the second electronic device 2.

First, in the communication system 100, the HT 2a and the printer 2b are set in a BT pairing enabled state with the HB 1a (step S20). Subsequently, when the tool is started, the connection terminal 3a notifies the HB 1a of the fact that the tool is started, via the wireless communication unit 34 (step S21). Upon receiving the notification, the HB 1a requests device information via the second wireless communication unit 15 (step S22), thereby searching for an available device as a partner of BT communication.

In step S22, the control unit 20 of each of the printer 2b and the HT 2a receives, via the wireless communication unit 25, a transmission request for transmitting device information from the HB 1a, which is to perform BT communication. Then, the control unit 20 transmits the device information as a response to the HB 1a via the wireless communication unit 25 (step S23), and transmits a transmission request of the device information on the HB 1a to the HB 1a (step S24). The HB 1a that receives the transmission request transmits the device information on the HB 1a to the printer 2b or HT 2a as a response (step S25).

Although not illustrated in FIG. 9, a search result is transmitted to the connection terminal 3a, and a list of available devices is displayed as illustrated in the UI image 33aB in FIG. 7. This list includes the devices SF-1 and PT-1, and a case will be described in which both devices are selected by the user. In this case, the connection terminal 3a transmits, to the HB 1a, by Wi-Fi Direct communication, via the wireless communication unit 34, instruction information instructing connection with the SF-1 and the PT-1 selected by the user.

The HB 1a receives the instruction information from the connection terminal 3a via the first wireless communication unit 14. As shown in a state shown in a communication system 100aD in FIG. 10, the HB 1a transmits a BT connection request to the SF-1 and the PT-1 indicated by the instruction information, that is, the HT 2a and the printer 2b. The transmission may be performed by the communication control unit 10a. In this state, the connection terminal 3a may display a message indicating that the HB 1a is connecting to the SF-1 and the PT-1 as illustrated in the UI image 33aD in FIG. 11.

Next, the control unit 20 of the HT 2a and the printer 2b receives the BT connection request from the HB 1a via the wireless communication unit 25, and in response to the BT connection request, attempts BT connection with the HB 1a with the wireless communication unit 25 to perform BT communication with the HB 1a. An HB 1a side also attempts the BT connection with the HT 2a and the printer 2b, but the HB 1a side may make the attempt either actively or passively. When the control unit 20 of each of the HT 2a and the printer 2b successfully connects to the HB 1a, BT communication is enabled.

Since the processing example is a processing example when the BT connection fails, a case where responses of connection permission to the BT connection request cannot be received from either device will be described. That is, a case will be described in which, as in step S26 in FIG. 9 and a state shown in a communication system 100aF in FIG. 10, even when BT pairing and connection are performed, the BT pairing fails and the BT connection cannot be established. In this state, the connection terminal 3a may display a message indicating that the connection fails as illustrated in a UI image 33aF in FIG. 11.

When connection to HB 1a fails, the control unit 20 of the printer 2b, for example, refers to device information on the printer 2b from the device information on HB 1a to determine if HB 1a is a device from the same vendor as the printer 2b. The control unit 20 of the HT 2a also performs the same determination. Here, an example will be described in which the printer 2b is a device from the same vendor as HB 1a, and the HT 2a is a device from a vendor different from HB 1a. The printer 2b automatically enables BT pairing again because HB 1a is the device from the same vendor (step S27). On the other hand, the HT 2a does not automatically enable the BT pairing again because the HB 1a is a device from a different vendor.

In this case, based on the device information on the second electronic device 2 where the BT pairing and connection fails, the communication control unit 10a retransmits a BT connection request requesting BT pairing and connection to only the printer 2b via the second wireless communication unit 15 (step S28). A state of step S28 indicates a state shown in a communication system 100aG in FIG. 10. Here, the communication control unit 10a also retransmits a BT connection request only to the printer 2b, because only the printer 2b is a device from the same vendor as the HB 1a. In this state, the connection terminal 3a may display a message indicating that the HB 1a is reconnecting to the PT-1 as illustrated in a UI image 33aG in FIG. 11.

Accordingly, the control unit 20 of the printer 2b receives again, via the wireless communication unit 25, the BT connection request transmitted from the HB 1a based on the device information on the printer 2b. As a response to the BT connection request, the control unit 20 of the printer 2b attempts connection with the HB 1a via the wireless communication unit 25 to perform BT communication with the HB 1a.

In particular, the control unit 20 of the printer 2b transmits connection permission to the HB 1a via the wireless communication unit 25 because the devices are from the same vendor (step S29). Accordingly, the HB 1a and the printer 2b succeed in BT pairing and connection, and start BT communication (step S30). On the other hand, the HB 1a does not start BT communication with the HT 2a. In this state, the connection terminal 3a may display a message indicating that the connection to the PT-1 is successful, as illustrated in a UI image 33aH in FIG. 11. The UI image 33aH may be erased after a certain period of time or by a user operation.

As described above, in the processing example, even when the BT connection fails, the BT connection request can be automatically transmitted again, that is, the BT connection can be automatically retried, and thus user convenience can be improved. In particular, with BT communication, pairing and connection may fail in some situations, such as when a device that emits 2.4 GHz radio waves, such as a microwave oven, is used nearby. However, even in such cases, the user does not need to perform any operations to reconnect.

### OTHER MODIFICATIONS

The present disclosure is not limited to the embodiment, and can be appropriately modified without departing from the scope of the present disclosure. For example, the devices such as the first electronic device, the second electronic device, and the terminal device applied to the communication system according to the embodiment are not limited to those illustrated.

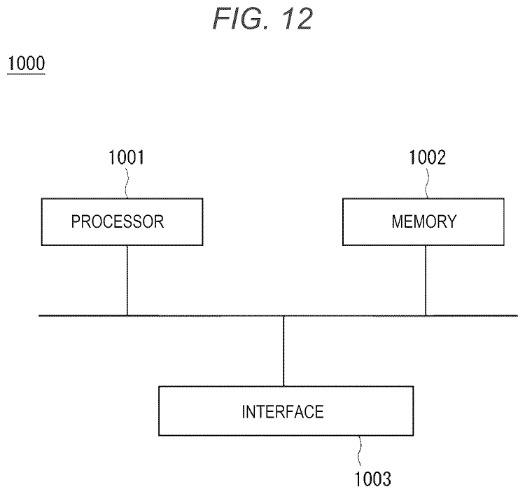

Devices such as the first electronic device, the second electronic device, and the terminal device in the communication system according to the above-described embodiment may have the following hardware configuration, for example. FIG. 12 is a diagram showing an example of a hardware configuration of a device.

A device 1000 shown in FIG. 12 may include a processor 1001, a memory 1002, and an interface 1003. The interface 1003 may include, for example, a communication interface or an interface with a sensor and an input-output device, which are necessary depending on the device.

The processor 1001 may be, for example, a CPU, a graphics processing unit (GPU), or a micro processor unit (MPU) also referred to as a microprocessor. The processor 1001 may include a plurality of processors. The memory 1002 is implemented, for example, with a combination of a volatile memory and a nonvolatile memory. Functions of the devices are implemented by the processor 1001 reading a program stored in the memory 1002 and executing the program while exchanging necessary information via the interface 1003.

The program contains an instruction group (or software codes) that causes a computer to provide one or more of the functions described in the embodiment when the program is loaded into the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD), and other memory technologies. Examples of the computer-readable medium or the tangible storage medium include, but are not limited to, a CD-ROM, a digital versatile disc (DVD), a Blu-ray (registered trademark) disk, another optical disk storage, a magnetic cassette, a magnetic tape, a magnetic disk storage, or another magnetic storage device. The program may be transmitted via a transitory computer-readable medium or a communication medium. The transitory computer-readable medium or the communication medium may be, but not limited to, a signal that propagates electrically, optically, acoustically, or in other forms.

The present disclosure is described with reference to the aforementioned embodiment. The present disclosure is not limited only to the configuration in the aforementioned embodiment, and it goes without saying that the present disclosure includes various variations, modifications, and combinations that can be achieved by those skilled in the art within the scope of the disclosure in the claims of the present application.

What is claimed is:

1. A first electronic device comprising:
a first wireless communication unit configured to perform first wireless communication with a terminal device by a first communication method;
a second wireless communication unit configured to perform Bluetooth communication with a second electronic device by a second communication method that is a communication method conforming to a Bluetooth standard; and
a communication controller configured to control the first wireless communication unit and the second wireless communication unit, wherein
the communication controller
performs searching for an electronic device that is a candidate for the second electronic device via the second wireless communication unit,
acquires, from the terminal device via the first wireless communication unit, instruction information instructing connection with the second electronic device to perform Bluetooth communication with the second wireless communication unit from among candidates obtained by the searching, and
transmits a connection request by the second communication method to the second electronic device indicated by the instruction information.

2. The first electronic device according to claim 1, wherein
when information instructing connection to a plurality of electronic devices serving as the second electronic device is acquired as the instruction information from the terminal device, the communication controller transmits a connection request by the second communication method to the plurality of electronic devices indicated by the instruction information.

3. The first electronic device according to claim 1, wherein
the communication controller
performs searching for an electronic device that is a candidate for the second electronic device, or transmits a transmission request via the second wireless communication unit to the candidate obtained by the searching to request transmission of device information,
acquires the device information via the second wireless communication unit as a response to the transmission request, and
when connection with the second electronic device indicated by the instruction information fails, retransmits a connection request by the second communication method to the second electronic device based on the device information.

4. The first electronic device according to claim 1, wherein
the first communication method is a communication method different from the communication method conforming to the Bluetooth standard.

5. The first electronic device according to claim 1, wherein
the first communication method is the communication method conforming to the Bluetooth standard.

6. A second electronic device comprising:
a wireless communication unit configured to perform Bluetooth communication with a first electronic device by a communication method conforming to a Bluetooth standard; and
a communication controller configured to control the wireless communication unit, wherein
the communication controller
receives, via the wireless communication unit, a transmission request for transmitting device information from the first electronic device to perform the Bluetooth communication,
in response to the transmission request, transmits the device information to the first electronic device via the wireless communication unit,
receives a connection request by the communication method from the first electronic device,
in response to the connection request, attempts connection with the first electronic device via the wireless communication unit to perform the Bluetooth communication with the first electronic device, and
when the connection with the first electronic device fails, receives again a connection request by the communication method transmitted from the first electronic device based on the device information.

7. A device connection method comprising:
by a first electronic device including a first wireless communication unit configured to perform first wireless communication with a terminal device by a first communication method and a second wireless communication unit configured to perform Bluetooth communication with a second electronic device by a second communication method that is a communication method conforming to a Bluetooth standard,
searching for an electronic device that is a candidate for the second electronic device, via the second wireless communication unit;
acquiring, from the terminal device via the first wireless communication unit, instruction information instructing connection with the second electronic device to perform Bluetooth communication with the second wireless communication unit from among candidates obtained by the searching; and
transmitting a connection request by the second communication method to the second electronic device indicated by the instruction information.

8. A device connection method comprising:
by a second electronic device including a wireless communication unit configured to perform Bluetooth communication with a first electronic device by a communication method conforming to a Bluetooth standard,
receiving, via the wireless communication unit, a transmission request for transmitting device information from the first electronic device to perform the Bluetooth communication;
in response to the transmission request, transmitting the device information to the first electronic device via the wireless communication unit;
receiving a connection request by the communication method from the first electronic device;
in response to the connection request, attempting connection with the first electronic device via the wireless communication unit to perform the Bluetooth communication with the first electronic device; and
when the connection with the first electronic device fails, receiving again a connection request by the communication method transmitted from the first electronic device based on the device information.
